(19) United States
(12) Patent Application Publication
(10) Pub. No.: US 2016/0034925 A1
(43) Pub. Date: Feb. 4, 2016

(54) SYSTEMS AND METHODS FOR IDENTIFYING CARDHOLDER STOCK-PILING BEHAVIOR

(71) Applicant: MasterCard International Incorporated, Purchase, NY (US)

(72) Inventors: Kenny Unser, Fairfield, CT (US); Kent Olof Niklas Berntsson, Rye, NY (US); Jean-Pierre Gerard, Croton-On-Hudson, NY (US)

(21) Appl. No.: 14/445,278

(22) Filed: Jul. 29, 2014

(51) Int. Cl. G06Q 30/02

(52) U.S. Cl. CPC G06Q 30/0202

(57) ABSTRACT

A computer-implemented method for identifying cardholder stock-piling behavior is implemented by a purchase analysis computer system in communication with a memory. The method includes retrieving at least one stock-piling profile used to identify transaction characteristics consistent with a stock-piling event wherein the stock-piling profile includes a plurality of ranges of expected cardholder transaction volumes associated with a plurality of categories of transactions, receiving a plurality of transaction data associated with the plurality of categories of transactions, determining an actual cardholder transaction volume for each of the plurality of categories of transactions, and identifying cardholder stock-piling behavior by comparing the actual cardholder transaction volume to the range of expected cardholder transaction volume for each of a plurality of categories of transactions.

### BACKGROUND OF THE DISCLOSURE

The field of the disclosure relates generally to improving merchant merchandising decisions, and more specifically to methods and systems for identifying cardholder stock-piling behavior.

In some examples, consumers may purchase excess amounts of goods or services in response to external phenomena. For example, a possible future ice storm may cause consumers to purchase significantly larger quantities of food and fuel than normal based on concern of limited access to food and fuel during the ice storm. Accordingly, in at least some cardholder-initiated financial transactions, cardholders (e.g., an entity using a payment card such as a credit card, a debit card, or a prepaid card) may purchase goods in excess of immediate or near-term needs due to external phenomena. Such behavior may be referred to as “stock-piling” of goods or categories of goods. In many examples, such cardholders stockpile only particular goods or categories of transactions in response to the external phenomena because only particular goods or categories of transactions are perceived to have a projected scarcity or rapid increase in value in the near future.

External phenomena may be exemplified in many forms. A first example may be an impending winter storm that triggers an exceptional number of people to buy milk and eggs at the super-market. A second example may be an impending hurricane that causes people to buy plywood, plastic sheeting and sand bags. A third example may be a financial panic that causes cardholders to withdraw large quantities of cash from bank balances.

Such stock-piling behavior may have significant impact on merchants providing goods or services that are being stock-piled or excessively accumulated. Merchants may be at risk of being unable to meet the needs of cardholders because their inventory is insufficient to meet the escalated demand Merchants may also be at risk of being unable to meet the needs of cardholders due to inefficient allocation of floor space to particular goods or services being stock-piled or understaffing of sales personnel to facilitate transactions. If merchants were able to identify stock-piling behavior earlier, the merchants may be able to mitigate adverse effects due to the stock-piling behavior. For example, merchants may order particular inventory in greater rates than normal and provide more of the inventory on the sales floor.

### BRIEF DESCRIPTION OF THE DISCLOSURE

In one aspect, a computer-implemented method for identifying cardholder stock-piling behavior is provided. The method is implemented by a purchase analysis computer system in communication with a memory. The method includes retrieving at least one stock-piling profile used to identify transaction characteristics consistent with a stock-piling event wherein the stock-piling profile includes a plurality of ranges of expected cardholder transaction volumes associated with a plurality of categories of transactions, receiving a plurality of transaction data associated with the plurality of categories of transactions, determining an actual cardholder transaction volume for each of the plurality of categories of transactions, and identifying cardholder stock-piling behavior by comparing the actual cardholder transaction volume to the range of expected cardholder transaction volume for each of a plurality of categories of transactions.

In another aspect, a purchase analysis computer system used to identify cardholder stock-piling behavior is provided. The purchase analysis computer system includes a processor, and a memory coupled to the processor. The purchase analysis computer system is configured to retrieve at least one stock-piling profile used to identify transaction characteristics consistent with a stock-piling event wherein the stock-piling profile includes a plurality of ranges of expected cardholder transaction volumes associated with a plurality of categories of transactions, receive a plurality of transaction data associated with the plurality of categories of transactions, determine an actual cardholder transaction volume for each of the plurality of categories of transactions, and identify cardholder stock-piling behavior by comparing the actual cardholder transaction volume to the range of expected cardholder transaction volume for each of a plurality of categories of transactions.

In a further aspect, computer-readable storage media for identifying cardholder stock-piling behavior is provided. The computer-readable storage media has computer-executable instructions embodied thereon. When executed by at least one processor, the computer-executable instructions cause the processor to retrieve at least one stock-piling profile used to identify transaction characteristics consistent with a stock-piling event wherein the stock-piling profile includes a plurality of ranges of expected cardholder transaction volumes associated with a plurality of categories of transactions, receive a plurality of transaction data associated with the plurality of categories of transactions, determine an actual cardholder transaction volume for each of the plurality of categories of transactions, and identify cardholder stock-piling behavior by comparing the actual cardholder transaction volume to the range of expected cardholder transaction volume for each of a plurality of categories of transactions.

### BRIEF DESCRIPTION OF THE DRAWINGS

The figures listed below show example embodiments of the methods and systems described herein.

FIGS. 1-7 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is an expanded block diagram of an example embodiment of server architecture used in payment transactions in accordance with one example embodiment of the present disclosure.

FIG. 3 illustrates an is an expanded block diagram of an example embodiment of a computer server system architecture of a system used to identify cardholder stock-piling behavior in accordance with one example embodiment of the present disclosure.

FIG. 4 illustrates an example configuration of a server system such as the purchase analysis computer system of FIGS. 2 and 3 used to identify cardholder stock-piling behavior in accordance with one example embodiment of the present disclosure.

FIG. 5 is a simplified data flow diagram of identifying cardholder stock-piling behavior using the systems of FIGS. 2, 3, and 4.

FIG. 6 is a simplified diagram of an example method of identifying cardholder stock-piling behavior using the systems of FIGS. 2, 3, and 4.

FIG. 7 is a diagram of components of one or more example computing devices that may be used in the environment shown in FIG. 6.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of the embodiments of the disclosure refers to the accompanying drawings. The same reference numbers in different drawings may identify the same or similar elements. Also, the following detailed description does not limit the claims.

Consumers may purchase excess amounts of goods or services in response to actual, anticipated, or predicted external phenomena. For example, a possible future ice storm may cause consumers to purchase significantly larger quantities of food and fuel than normal based on a concern of limited access to food and fuel during the anticipated ice storm.

Alternately, in a second example, a product may be anticipated to become scarce. In some examples, changes in the output of oil refineries may anticipated make access to gasoline decrease and cause consumers to purchase significantly higher quantities of gasoline due to an anticipated shortage or anticipated price increase. In other examples, a product may be known to be scarce due to unusual demand. For example, certain gift items may become very popular as gifts during the holiday seasons and consumers may purchase multiples of such products for resale purposes.

Accordingly, in at least some cardholder-initiated financial transactions, cardholders (e.g., an entity using a payment card such as a credit card, a debit card, or a prepaid card) may purchase goods in excess of immediate or near-term needs due to external phenomena. External phenomena, as described above and herein, may include any natural or manmade phenomenon that alters consumer purchasing behaviors. Such resulting consumer behavior may be referred to as “stock-piling” of goods or categories of goods. In many examples, such cardholders stockpile only particular goods or categories of transactions in response to the external phenomena because only particular goods or categories of transactions are perceived to have a projected scarcity or rapid increase in value in the near future.

External phenomena may be exemplified in many forms. A first example may be an impending winter storm that triggers an exceptional number of people to buy milk and eggs at the super-market. A second example may be an impending hurricane that causes people to buy plywood, plastic sheeting and sand bags. A third example may be a financial panic that causes cardholders to withdraw large quantities of cash from bank balances.

Such stock-piling behavior may have significant impact on merchants providing goods or services that are being stock-piled or excessively accumulated. Merchants may be at risk of being unable to meet the needs of cardholders because their inventory is insufficient to meet the escalated demand. Merchants may also be at risk of being unable to meet the needs of cardholders due to inefficient allocation of floor space to particular goods or services being stock-piled or understaffing of sales personnel to facilitate transactions. If merchants were able to identify stock-piling behavior earlier, the merchants may be able to mitigate adverse effects due to the stock-piling behavior. For example, merchants may order particular inventory in greater rates than normal and provide more of the inventory on the sales floor.

As a result, it may be advantageous for merchants to predict or identify stock-piling behavior. Earlier prediction or determination of stock-piling behavior may allow a merchant to increase revenue due to increased acquisition of stock-piled merchandise and to increase customer satisfaction by avoiding the risk that a stock-piled product becomes unavailable.

Accordingly, the systems and methods described herein facilitate the identification of cardholder stock-piling behavior. The systems and methods described are facilitated by a purchase analysis computer system including a processor in communication with a memory. Specifically, the methods and systems described herein include (i) retrieving at least one stock-piling profile used to identify transaction characteristics consistent with a stock-piling event wherein the stock-piling profile includes a plurality of ranges of expected cardholder transaction volumes associated with a plurality of categories of transactions, (ii) receiving a plurality of transaction data associated with the plurality of categories of transactions, (iii) determining, at the purchase analysis computer system, an actual cardholder transaction volume for each of the plurality of categories of transactions, and (iv) identifying behavior cardholder stock-piling behavior by comparing the actual cardholder transaction volume to the range of expected cardholder transaction volume for each of a plurality of categories of transactions.

The purchase analysis computer system generates stock-piling profiles by analyzing historical transaction data. “Historical transaction data” represents previously processed transaction data from previous consumer transactions. In at least one example, historical transaction data may be stored at a transaction data database associated with the purchase analysis computer system. In alternative examples, historical transaction data may be stored at other systems or received from a payment network computer system associated with the payment network.

The purchase analysis computer system receives historical transaction data associated with a plurality of historical transactions. Such historical transaction data may be associated with a plurality of cardholders and a plurality of merchants. The historical transaction data may include elements including transaction amounts, transaction volumes, transaction categories, product identifiers, transaction location, cardholder residence location, merchant location, transaction date and time, merchant identifiers, and cardholder numbers.

However, in some examples, received historical transaction data may not include all such elements and the purchase analysis computer system may infer elements. For example, historical transaction data may not include cardholder residence location. The purchase analysis computer system may process historical transaction data to predict a likely cardholder residence location based on merchant locations for historical transaction data associated with the cardholder. Similarly, not all historical transaction data may include transaction categories. However, transaction categories may be determined based on merchant identifiers. For example, a merchant identifier “ABC” associated with a hardware store may be identified by the purchase analysis computer system. The purchase analysis computer system may determine that historical transaction data with a merchant identifier of “ABC” may have a transaction category of “Hardware”.

The purchase analysis computer system processes such historical transaction data to generate stock-piling profiles. As described herein, stock-piling profiles include expected characteristics of cardholder transactions when stock-piling is not occurring. In other words, stock-piling profiles define normal characteristics of transaction data in the absence of external phenomena that causes stock-piling. Such characteristics vary in type. Stock-piling profile characteristics may include, for example, and without limitation, transaction volumes, transaction amounts, distance traveled for purchase, frequency of purchase, frequency of purchase by each cardholder. Further, as noted below, such characteristics may be associated with segmentations including particular time periods, particular geographic areas, and particular transaction categories. Such segmentations allow the purchase analysis computer system to distinguish characteristics in different conditions. For example, the transaction volume expected for grocery transactions between midnight and 4:00 AM may be substantially different from the transaction volume expected between 4:00 PM and 8:00 PM. Additionally, the distance traveled by cardholders for grocery transactions in a first urban geographic region may be less than the distance traveled by cardholders for grocery transactions in a second rural geographic region. (This assumes that grocery stores are more densely available in urban geographic regions than in rural geographic regions.) Further, stock-piling profiles may include tolerance ranges for each characteristic and segmentation. Such tolerance ranges reflect an amount by which transaction data may exceed expected cardholder transaction characteristics before it is flagged as potentially tied to stock-piling behavior. For example, the historical transaction data may indicate an average value for each characteristic but a distribution of the historical transaction data for each characteristic may indicate that much of the transaction data deviates from the average. Therefore, a threshold may be determined based in part on the distribution of the historical transaction data associated with each characteristic of the stock-piling profile. A first illustrative stock-piling profile is displayed below, segmented by transaction categories (Table 1):

TABLE 1

| | | | | Expected | Expected |
|---|---|---|---|---|---|
| | Expected | Expected | | Distance | Frequency |
| | Transactions | Transaction | | Traveled | of Purchase |
| Transaction | Volume per | Amount per | | per | per |
| Categories | Day | Day | | Transaction | Transaction |
| Grocery | 100,000,000 | $5 | billion | 10 miles | 1 transaction |
| | | | | | per 10 days |
| Hardware | 5,000,000 | $50 | million | 15 miles | 1 transaction |
| | | | | | per 60 days |
| Gasoline | 150,000,000 | $6 | billion | 5 miles | 1 transaction |
| | | | | | per 7 days |

Table 1 serves as a first illustration of a simple form of a stock-piling profile because it is not fully segmented. The stock-piling profile of Table 1 is generally segmented by transaction category. Expected transaction and expected transaction amount are additionally segmented by day. Expected distance traveled and expected frequency of purchase are segmented by transaction. In many examples, further segmentation will be useful to account for regional, temporal, or merchant variation. Such additional segmentation can improve the effectiveness of the stock-piling profiles in detecting variances. Because external phenomena may be significantly associated with regions and time periods, a more detailed and segmented stock-piling profile may be beneficial. A second illustrative stock-piling profile is displayed below, segmented by transaction categories, and regions (Table 2). To simplify the display of the stock-piling profile to the reader, fewer characteristics are indicated. However, it is understood that additional characteristics may be included:

TABLE 2

| | | Expected | Expected | | Expected |
|---|---|---|---|---|---|
| | | Transaction | Transaction | | Distance |
| Transaction | | Volume per | Amount per | | Traveled per |
| Categories | | Day | Day | | Transaction |
| Grocery | Region A | 30,000,000 | $.5 | billion | 5 miles |
| | Region B | 20,000,000 | $2 | billion | 15 miles |
| | Region C | 50,000,000 | $2.5 | billion | 10 miles |
| Hardware | Region A | 500,000 | $10 | million | 20 miles |
| | Region B | 2,500,000 | $20 | million | 5 miles |
| | Region C | 2,000,000 | $20 | million | 5 miles |
| Gasoline | Region A | 40,000,000 | $2.1 | billion | 3 miles |
| | Region B | 60,000,000 | $2.4 | billion | 10 miles |
| | Region C | 50,000,000 | $1.5 | billion | 10 miles |

The example stock-piling profiles indicated in Tables 1 and 2 are provided for explication only. They are not restrictive and it should be understood that the stock-piling profiles generated and used by the purchase analysis computer system may be significantly different and more complex than the stock-piling profiles illustrated above. Further, stock-piling profiles may further have thresholds for characteristics as described above and herein. Depending upon factors including the distribution of characteristics in historical transaction data, greater or lesser thresholds for variance from the stock-piling profile may be allowed. In the example of Table 2, for example, Region A may include a broad distribution of distances traveled for grocery transactions. For example, 70% of all transactions may include travel of over 10 miles while 30% of all transactions include travel of less than 2 miles. As a result, an average expected range of travel for grocery transactions in Region A may be 5 miles but many examples of expected ranges of travel may exceed 5 miles. In this example, a tolerance of travel of 10 miles may be indicated.

Further, although many stock-piling profiles are determined to include characteristics based on averages from the historical transaction data, other stock-piling profiles may use additional mathematical models to determine such characteristics. Any suitable statistical or mathematical model may be used to determine such profile characteristics. Additionally, as described below, at least some stock-piling profiles are generated by comparing periods known to be impacted by external phenomena to periods not impacted by external phenomena.

In the example embodiment, the purchase analysis computer system identifies patterns of cardholder transaction volumes for the plurality of categories of transactions. In the example embodiment, the purchase analysis computer system generates stock-piling profiles with characteristics for cardholder transaction volumes segmented by transaction categories. More specifically, the purchase analysis computer system determines normal or expected ranges for cardholder transaction volumes for the plurality of categories of transactions. Based on the determined normal or expected ranges of cardholder transaction volume, the purchase analysis computer system generates stock-piling profiles. The stock-piling profile may indicate a normal or expected transaction volume for each category of transaction as segmented by date, time, location, or other segmentation factors. For example, some businesses may be seasonal or otherwise time-sensitive and have substantially different transaction volumes depending upon time of day or time of year. Therefore, stock-piling profiles that take such temporal variance into account are more useful for identifying stock-piling behavior.

As described above, in other examples, the purchase analysis computer system generates stock-piling profiles with other characteristics. Such stock-piling profiles may identify transaction amounts (as expressed in currency values), distance traveled for purchases (by comparing merchant location to cardholder residence location), frequency of purchase in a time period, and frequency of purchase in a time period by a particular cardholder. Stock-piling profiles with such additional information may also be segmented in a similar manner.

Including transaction amounts in the characteristics may be useful to identify stock-piling consumers that are making transactions of significant financial amounts. For example, consumers may make similar numbers of transactions while significantly increasing transaction amounts. In such examples, the consumers may be stock-piling even though transaction volume is unaffected. In such examples, the purchase analysis computer system receives the plurality of historical transaction data and determines transaction amounts generally and for each segmentation. Based on the determined transaction amounts (and segmented transaction amounts), the stock-piling profile may be determined.

Including distance traveled for purchases in the characteristics may be useful to determine typical ranges of travel. As described below, if consumers are purchasing products from merchant locations at much greater distances from the cardholder residence location, the purchase analysis computer system may determine that such consumers are doing so to access more products that are becoming scarce due to stock-piling activity. In such examples, the purchase analysis computer system receives the plurality of historical transaction data and determines distances traveled for each segmentation. As noted above, in some examples, a cardholder residence location may first be derived based on other historic transaction data associated with each cardholder. Similarly, a merchant location may be derived based on a merchant identifier or a merchant zip code. Based on the determined distances traveled (and segmented distances traveled), the stock-piling profile may be determined.

Including frequency of purchase generally may be useful to determine typical ranges of frequency of purchase. Similarly, frequency of purchase per cardholder may be useful to verify that individual cardholders are purchasing at greater frequency (as opposed to a sudden increase in popularity of a particular merchant or transaction category). Based on the determined frequencies of purchase (and segmented frequencies of purchase), the stock-piling profile may be determined.

In at least some examples, the purchase analysis computer system additionally generates stock-piling profiles by factoring in external phenomena. In other words, at least some stock-piling profiles determine the normal or expected transaction characteristics at least partially by comparing such characteristics in time periods that are influenced by external phenomena and time periods that are known to not be influenced by external phenomena. In such examples, the purchase analysis computer system may receive external phenomena information that allows the purchase analysis computer system to identify historical transaction data associated with the external phenomena. Such external phenomena information may include dates and times associated with the external phenomena, geographical regions associated with the external phenomena, transaction categories associated with the external phenomena. Alternately, external phenomena may include any other suitable information. In one example, external phenomena information includes information related to an ice storm. Such external phenomena information may include the date of the announcement of the ice storm, the date of the impact of the ice storm, the geographical regions impacted by the ice storm, and transaction categories affected by the ice storm (e.g., fuel and groceries). Such external phenomena information may be substantially more detailed and identify the severity of the external phenomena as well as reported information on the impact of stock-piling due to the external phenomena. When such external phenomena information is available, the purchase analysis computer system identifies historical transaction data that is associated with the external phenomena information as external phenomena transaction data. The purchase analysis computer system processes such identified external phenomena transaction data in generating the stock-piling profiles. In one example, the external phenomena transaction data is excluded from the sample that is used to generate the expected ranges of characteristics for the stock-piling profiles (because such external phenomena transaction data necessarily does not describe normal consumer transaction behavior). In a second example, the external phenomena transaction data is processed to determine models of expected deviations from characteristics caused by external phenomena. In all such examples, the external phenomena transaction data is used to adjust the stock-piling profile.

In further examples, the purchase analysis computer system may analyze historical transaction data to identify patterns of characteristics in various segmentations. Where characteristics significantly deviate from the normal characteristics, the purchase analysis computer system may flag or otherwise identify such deviations as potentially associated with external phenomena. The purchase analysis computer system may adjust the stock-piling profiles by ignoring such deviations or alternately adjusting the impact of such deviations. In other examples, a user may review the identified deviations for further analysis.

In at least some examples, concerns regarding access to banks or ATMs may cause consumers to withdraw larger amounts of money than are normal. Therefore, in at least some examples, stock-piling profiles are generated specifically for the transaction category of bank transactions. In other words, stock-piling profiles may include characteristics associated with the withdrawal of money from a financial account or any other transactions associated with a financial account. Such stock-piling profiles for bank transactions may include similar characteristics, segmentations, and thresholds to those described above and herein. Specifically, transaction volumes, transaction amounts, distances traveled for transactions, and frequencies of transactions may be included in characteristics that are further segmented by date, time, and geographic region.

The purchase analysis computer system retrieves at least one generated stock-piling profile, as described above, which may be used to identify transaction characteristics consistent with a stock-piling event. As indicated above, each stock-piling profile includes a plurality of ranges of expected cardholder characteristics and a plurality of segmentations. In one example, the stock-piling profile includes a plurality of expected cardholder transaction volumes segmented by transaction category and further segmented by date and time. In another example, the stock-piling profile is further segmented by geographic region or area.

The purchase analysis computer system also receives a plurality of transaction data associated with a plurality of categories of transactions. In the example embodiment, the transaction data represents present or recent data associated with present or recent transactions.

The purchase analysis computer system aggregates transaction data from a plurality of transactions generally, and for each segmentation indicated in the stock-piling profiles. Accordingly, the purchase analysis computer system determines actual cardholder transaction characteristics (e.g., actual cardholder transaction volume) for each segmentation (e.g., for each transaction category.) In at least some examples, the purchase analysis computer system may determine actual cardholder transactions characteristics for each segmentation.

The purchase analysis computer system identifies cardholder stock-piling behavior by comparing the actual cardholder transaction characteristics to the range of expected cardholder transaction characteristics, generally, and for each segmentation. In one example, the purchase analysis computer system identifies cardholder stock-piling behavior by comparing the actual cardholder transaction volume to the range of expected cardholder transaction volume for each of a plurality of categories of transactions. More specifically, the purchase analysis computer system identifies whether actual cardholder transaction volume for each of the plurality of categories deviates from the expected values of the expected cardholder transaction volumes indicated in the stock-piling profiles. In at least some examples, the purchase analysis computer system further factors in determined thresholds to identify potential stock-piling behavior. As described above, at least some characteristics may include distributions where a range of “normal” characteristics may exist. In such examples, even though the actual cardholder transaction characteristics may vary from the characteristics of the stock-piling profile, such variation may not exceed the defined threshold and stock-piling behavior may not be identified.

Because at least some segmentation is geographic and temporal in nature, the stock-piling behavior may be identified for a particular region rather than generally. In other words, in some examples, actual cardholder transaction characteristics will indicate stock-piling behavior in a particular region or for a particular transaction category but not in other regions or other transaction categories.

In some examples, actual cardholder transaction characteristics may deviate from some stock-piling profile characteristics but not from others. In other words, in some examples, some actual cardholder transaction characteristics may indicate stock-piling behavior while others do not. The purchase analysis computer system may be configured to only identify stock-piling behavior when the actual cardholder transaction characteristics deviate from a sufficient number of characteristics, as defined for each stock-piling profile. Such sufficient number of characteristics may be defined by a user or by the purchase analysis computer system. In other examples, particular characteristics may be more determinative than others in identifying stock-piling behavior. In such examples, the particular characteristics and their importance may be defined by a user or by the purchase analysis computer system.

In at least some examples, the purchase analysis computer system may further be configured to alert merchants that may be impacted by identified stock-piling behavior. For example, merchants that are in a geographic region associated with the stock-piling behavior may be notified. Alternately, merchants associated with a transaction category associated with the stock-piling behavior may be notified. Such alerts 580 may be notifications of the stock-piling behavior generally. Alternately, the purchase analysis computer system may indicate a severity rating, wherein the severity rating indicates the severity of the stock-piling behavior. The alert may also indicate suggested responses. In one example, alerted merchants may be advised to obtain more merchandise that is subject to being stock-piled. In another example, alerted merchants may be advised to increase prices on stock-piled merchandise to reduce stock-piling behavior. In an additional example, merchants may be advised to change operating hours to respond to the stock-piling behavior.

In at least some examples, the purchase analysis computer system may further alert other parties that may be affected by the stock-piling behavior including, for example, government agencies, news outlets, emergency services, and healthcare services.

As noted above, at least some stock-piling profiles are generated for the specific case of bank transactions. In such examples, the purchase analysis computer system is configured to retrieve the at least one stock-piling profile wherein the at least one stock-piling profile includes a range of expected cardholder characteristics associated with using a transaction card such as a debit card. In some examples, the range of expected cardholder characteristics is further determined for a particular location, a particular time interval, or a particular category of account holders. Such expected cardholder characteristics may include the expected rate of withdrawal or deposit to or from cardholder financial accounts. The purchase analysis computer system also receives a plurality of transaction data associated with transaction card (e.g., a debit card) withdrawals from an associated cardholder financial account and determines actual transaction card characteristics. The purchase analysis computer system also identifies cardholder stock-piling behavior by comparing the actual transaction card characteristics to the range of expected cardholder characteristics associated with using transaction cards.

Further, at least some additional stock-piling profiles are generated including characteristics of the expected or normal distance of travel for transactions. In such examples, the purchase analysis computer system is configured to retrieve at least one stock-piling profile including characteristics of a geographic range associated with an expected distance that cardholders will travel for each segmentation and generally. The purchase analysis computer system is also configured to determine an average distance traveled by cardholders for each segmentation and generally based on the transaction data. The purchase analysis computer system is also configured to identify cardholder stock-piling behavior by comparing the expected distance that cardholders will travel to the average distance traveled by cardholders generally and for each segmentation.

Through the identification of cardholder stock-piling behavior, the systems and methods are further configured to facilitate (a) identifying the impact radius and resource needs of communities impacted by external phenomena, (b) identifying opportunities for merchants to move stock to areas where goods are in high demand, (c) alert merchants to the existence of nearby stock-piling activity, and (d) improved response from government, emergency, health, and news organizations.

More specifically, the technical effects can be achieved by performing at least one of the following steps: (a) retrieving at least one stock-piling profile used to identify transaction characteristics consistent with a stock-piling event wherein the stock-piling profile includes a plurality of ranges of expected cardholder transaction volumes associated with a plurality of categories of transactions; (b) receiving a plurality of transaction data associated with the plurality of categories of transactions; (c) determining, at the purchase analysis computer system, an actual cardholder transaction volume for each of the plurality of categories of transactions; (d) identifying cardholder stock-piling behavior by comparing the actual cardholder transaction volume to the range of expected cardholder transaction volume for each of a plurality of categories of transactions; (e) receiving a plurality of historical transaction data associated with each of the plurality of categories of transactions; (f) determining a plurality of ranges of expected cardholder transaction volumes associated with the plurality of categories of transactions based on the historical transaction data; (g) generating the at least one stock-piling profile based on the determined plurality of ranges of expected cardholder transaction volumes; (h) receiving a time range associated with at least one external phenomena; (i) identifying variations between cardholder transaction volumes during the time range and cardholder transaction volumes not during the time range; (j) adjusting the at least one stock-piling profile based on the identified variations; (k) determining a plurality of geographic regions; (l) identifying cardholder stock-piling behavior for each of the determined plurality of geographic regions; (m) alerting a plurality of merchants associated with identified cardholder stock-piling behavior; (n) recommending an inventory response to the plurality of merchants based on the identified cardholder stock-piling behavior; (o) retrieving the at least one stock-piling profile wherein the at least one stock-piling profile includes a range of expected cardholder withdrawals from an associated cardholder financial account using a transaction card; (p) receiving the plurality of transaction data associated with debit card withdrawals; (q) determining an actual debit card withdrawal amount; (r) identifying cardholder stock-piling behavior by comparing the actual debit card withdrawal amount to the range of expected cardholder withdrawals from an associated cardholder financial account using a transaction card; (s) retrieving the at least one stock-piling profile wherein the at least one stock-piling profile includes a geographic range associated with an expected distance that cardholders will travel to purchase particular goods; (t) determining, based on the transaction data, an average distance traveled by cardholders for each of the plurality of categories of transactions; and (u) identifying cardholder stock-piling behavior by comparing the expected distance that cardholders will travel to purchase particular goods to the average distance traveled by cardholders for each of the plurality of categories of transactions.

By performing these steps, the resultant technical effects include at least enabling merchants to predict stock-piling behavior, to identify present or ongoing stock-piling behavior, to respond to stock-piling behavior with changed merchandising or management strategies, and to improve customer satisfaction.

Described herein are computer systems such as purchase analysis computer systems and related computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the determination and analysis of characteristics of devices used in payment transactions.

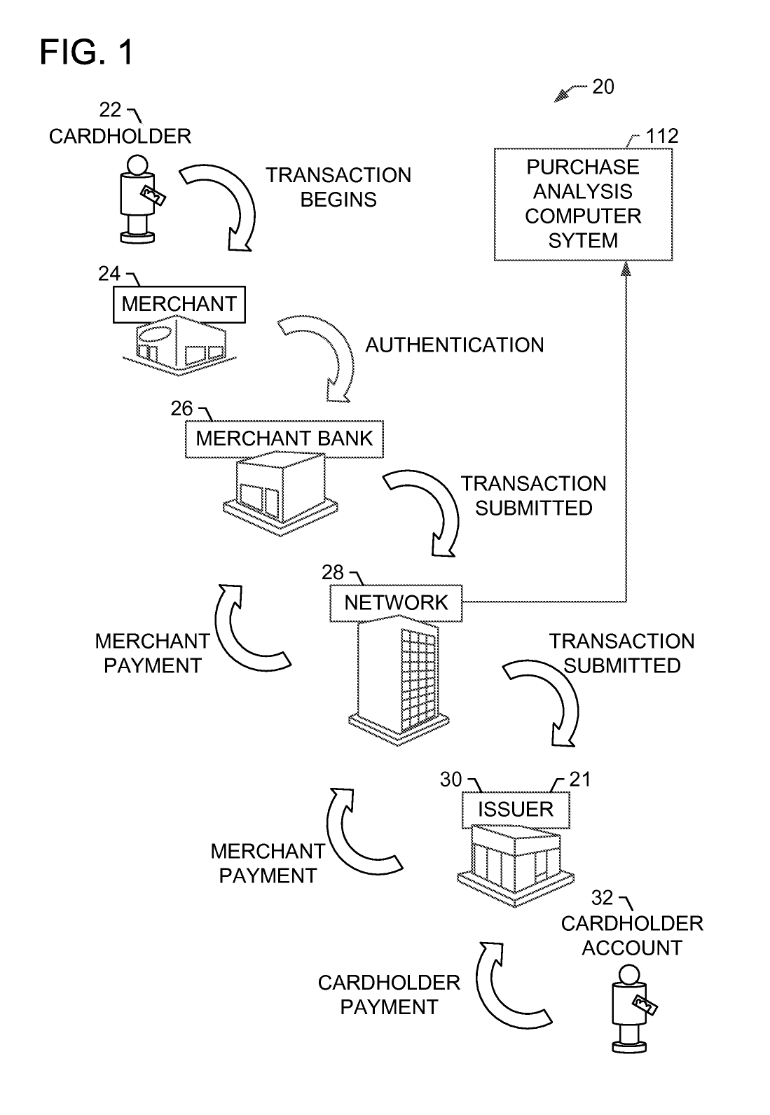

FIG. 1 is a schematic diagram illustrating an example multi-party transaction card industry system 20 for enabling ordinary payment-by-card transactions, including payment-by-card transactions made by cardholders using cardholder computing devices to initiate transactions at an online merchant, in which merchants 24 and card issuers 30 do not need to have a one-to-one special relationship. Typical financial transaction institutions provide a suite of interactive, online applications to both current and prospective customers. For example, a financial transactions institution may have a set of applications that provide informational and sales information on their products and services to prospective customers, as well as another set of applications that provide account access for existing cardholders.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

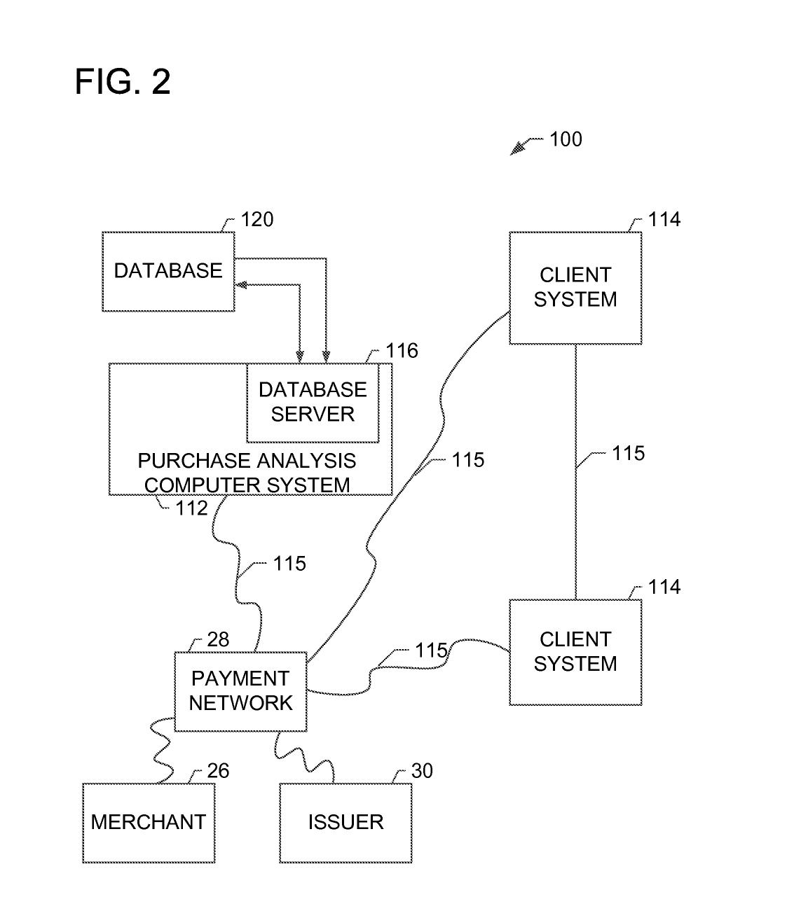

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including purchase analysis computer system 112. In the example embodiment, interchange network 28 provides such transaction data and additional transaction data such as historical transaction data. In alternative embodiments, any party may provide such transaction data and historical transaction data to purchase analysis computer system 112.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, purchase analysis computer system 112 may be used to identify stock-piling behavior and alert merchants such as merchant 24 using transaction data and historical transaction data received from, for example, interchange network 28. Although the systems described herein are not intended to be limited to facilitate such applications, the systems are described as such for exemplary purposes.

FIG. 2 is a simplified block diagram of an example computer system 100 used to identify cardholder stock-piling behavior in accordance with the present disclosure. In the example embodiment, system 100 is used for retrieving at least one stock-piling profile used to identify transaction characteristics consistent with a stock-piling event wherein the stock-piling profile includes a plurality of ranges of expected cardholder transaction volumes associated with a plurality of categories of transactions, receiving a plurality of transaction data associated with the plurality of categories of transactions, determining an actual cardholder transaction volume for each of the plurality of categories of transactions, and identifying cardholder stock-piling behavior by comparing the actual cardholder transaction volume to the range of expected cardholder transaction volume for each of a plurality of categories of transactions, as described herein. In other embodiments, the applications may reside on other computing devices (not shown) communicatively coupled to system 100, and may identify stock-piling behavior using system 100.

More specifically, in the example embodiment, system 100 includes a purchase analysis computer system 112, and a plurality of client sub-systems, also referred to as client systems 114, connected to purchase analysis computer system 112. In one embodiment, client systems 114 are computers including a web browser, such that purchase analysis computer system 112 is accessible to client systems 114 using the Internet. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with cardholders 22 (shown in FIG. 1) as well as external systems used to store review data (“external review resources”). Purchase analysis computer system 112 is also in communication with payment network 28 using network 115. Further, client systems 114 may additionally communicate with payment network 28 using network 115. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on purchase analysis computer system 112 and can be accessed by potential users at one of client systems 114 by logging onto purchase analysis computer system 112 through one of client systems 114. In an alternative embodiment, database 120 is stored remotely from purchase analysis computer system 112 and may be non-centralized.

Database 120 may include a single database having separated sections or partitions, or may include multiple databases, each being separate from each other. Database 120 may store transaction data generated over the processing network including data relating to merchants, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authorization request data. Further, as described herein, database 120 may contain historical transaction data, transaction data, stock-piling profiles, segmentations for stock-piling profiles, thresholds for stock-piling profiles, and models and algorithms used for processing and using stock-piling profiles.

In the example embodiment, one of client systems 114 may be associated with acquirer bank 26 (shown in FIG. 1) while another one of client systems 114 may be associated with issuer bank 30 (shown in FIG. 1). Purchase analysis computer system 112 may be associated with interchange network 28. In the example embodiment, purchase analysis computer system 112 is associated with a network interchange, such as interchange network 28, and may be referred to as an interchange computer system. Purchase analysis computer system 112 may be used for processing transaction data. In addition, client systems 114 may include a computer system associated with at least one of an online bank, a bill payment outsourcer, an acquirer bank, an acquirer processor, an issuer bank associated with a transaction card, an issuer processor, a remote payment system, customers and/or billers.

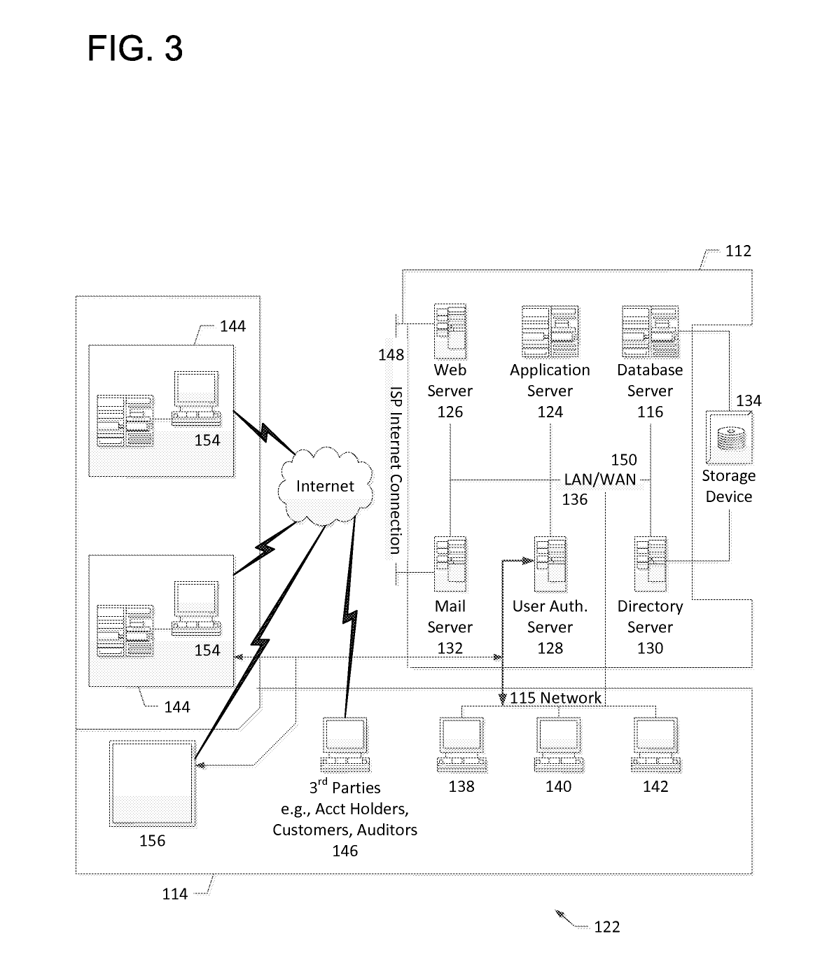

FIG. 3 is an expanded block diagram of an example embodiment of a computer server system architecture of a processing system 122 used to identify stock-piling behavior in accordance with one embodiment of the present disclosure. Components in system 122, identical to components of system 100 (shown in FIG. 2), are identified in FIG. 3 using the same reference numerals as used in FIG. 2. System 122 includes purchase analysis computer system 112, client systems 114, and payment systems 118. Purchase analysis computer system 112 further includes database server 116, a transaction server 124, a web server 126, a user authentication server 128, a directory server 130, and a mail server 132. A storage device 134 is coupled to database server 116 and directory server 130. Servers 116, 124, 126, 128, 130, and 132 are coupled in a local area network (LAN) 136. In addition, an issuer bank workstation 138, an acquirer bank workstation 140, and a third party processor workstation 142 may be coupled to LAN 136. In the example embodiment, issuer bank workstation 138, acquirer bank workstation 140, and third party processor workstation 142 are coupled to LAN 136 using network connection 115. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Purchase analysis computer system 112 is configured to be operated by various individuals including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150. Purchase analysis computer system 112 is also configured to be communicatively coupled to payment systems 118. Payment systems 118 include computer systems associated with merchant bank 26, interchange network 28, issuer bank 30 (all shown in FIG. 1), and interchange network 28. Additionally, payments systems 118 may include computer systems associated with acquirer banks and processing banks. Accordingly, payment systems 118 are configured to communicate with purchase analysis computer system 112 and provide transaction data as discussed below.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with purchase analysis computer system 112.

Also, in the example embodiment, web server 126, application server 124, database server 116, and/or directory server 130 may host web applications, and may run on multiple server systems 112. The term “suite of applications,” as used herein, refers generally to these various web applications running on server systems 112.

Furthermore, user authentication server 128 is configured, in the example embodiment, to provide user authentication services for the suite of applications hosted by web server 126, application server 124, database server 116, and/or directory server 130. User authentication server 128 may communicate with remotely located client systems, including a client system 156. User authentication server 128 may be configured to communicate with other client systems 138, 140, and 142 as well.

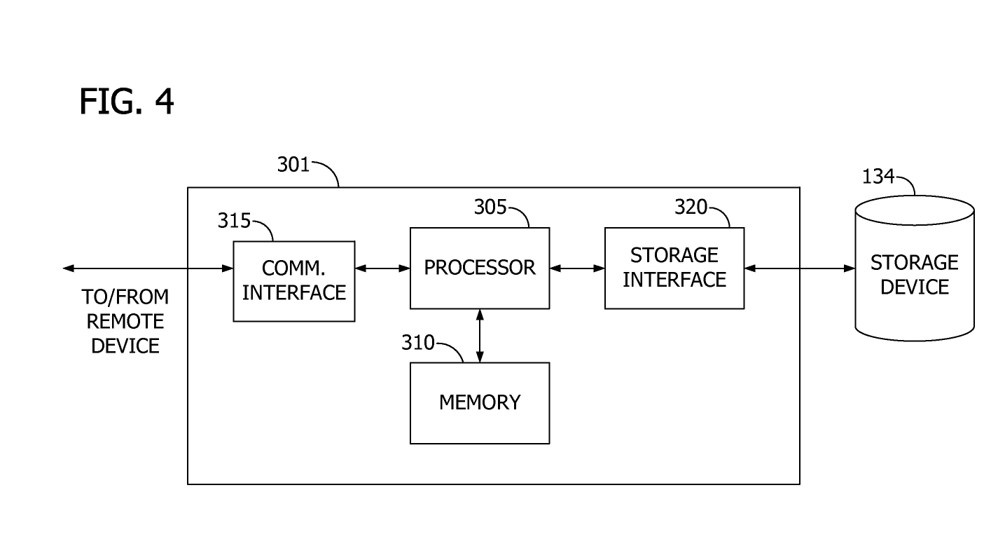

FIG. 4 illustrates an example configuration of a server system 301 such as purchase analysis computer system 112 (shown in FIGS. 2 and 3). Server system 301 may include, but is not limited to, database server 116, transaction server 124, web server 126, user authentication server 128, directory server 130, and mail server 132. In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

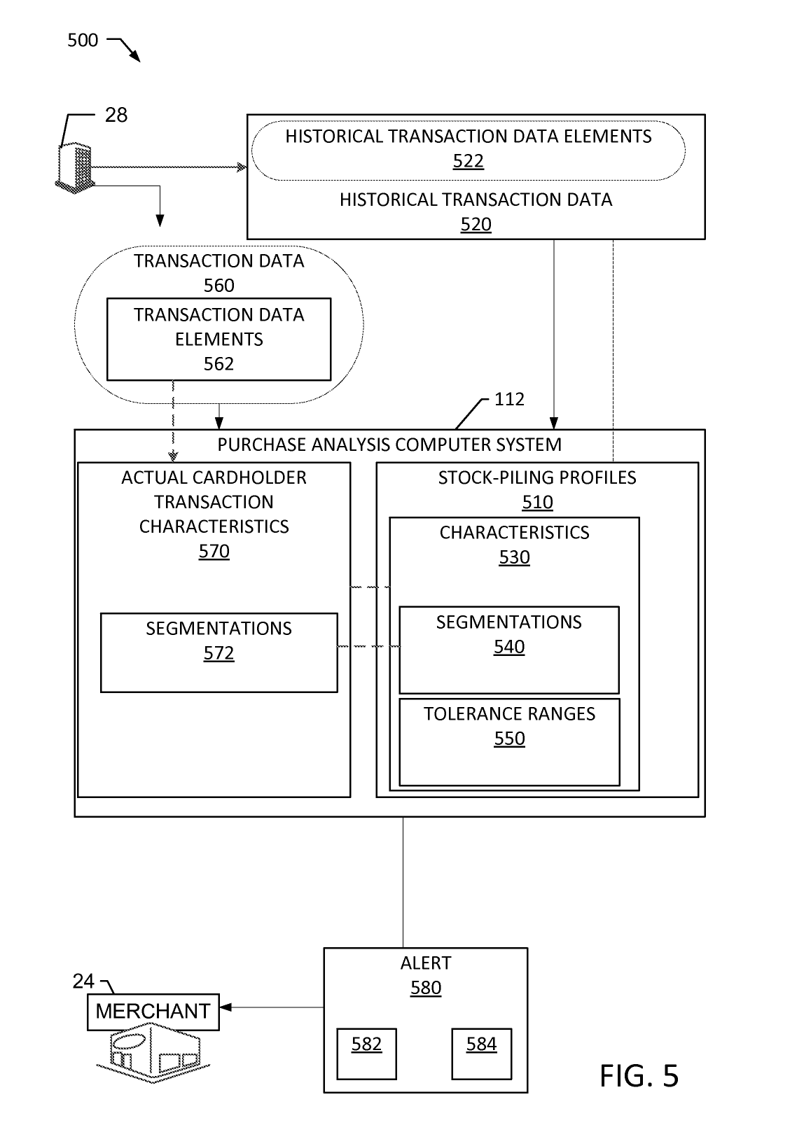

FIG. 5 is a simplified data flow diagram 500 of identifying stock-piling behavior using purchase analysis computer system 112 of FIGS. 2, 3, and 4. Purchase analysis computer system 112 generates stock-piling profiles 510 by analyzing historical transaction data 520. Historical transaction data 520 represents previously processed transaction data from previous consumer transactions. In at least one example, historical transaction data may be stored at a transaction data database 120 (shown in FIG. 2) associated with purchase analysis computer system 112. In alternative examples, historical transaction data 520 may be stored at other systems or received from a payment network computer system associated with payment network 28.

Purchase analysis computer system 112 receives historical transaction data 520 associated with a plurality of historical transactions. Such historical transaction data 520 may be associated with a plurality of cardholders and a plurality of merchants. The historical transaction data may include elements 522 including transaction amounts, transaction volumes, transaction categories, product identifiers, transaction location, cardholder residence location, merchant location, transaction date and time, merchant identifiers, and cardholder numbers.

However, in some examples, received historical transaction data 520 may not include all such elements 522 and purchase analysis computer system 112 may infer elements 522. For example, historical transaction data 520 may not include cardholder residence location. Purchase analysis computer system 112 may process historical transaction data 520 to predict a likely cardholder residence location based on merchant locations for historical transaction data associated with the cardholder. Similarly, not all historical transaction data 520 includes transaction categories. However, transaction categories may be determined based on merchant identifiers. For example, a merchant identifier “ABC” associated with a hardware store may be identified by purchase analysis computer system 112. Purchase analysis computer system 112 may determine that historical transaction data 520 with a merchant identifier of “ABC” may have a transaction category of “Hardware”.

Purchase analysis computer system 112 processes such historical transaction data 520 to generate stock-piling profiles 510. As described herein, stock-piling profiles 510 include expected characteristics 530 of cardholder transactions when stock-piling is not occurring. In other words, stock-piling profiles 510 define normal characteristics 530 of transaction data (including current transaction data 560 or historical transaction data 520) in the absence of external phenomena that causes stock-piling. Such characteristics 530 vary in type. Characteristics 530 may include, for example, and without limitation, transaction volumes, transaction amounts, distance traveled for purchase, frequency of purchase, frequency of purchase by each cardholder. Further, as noted below, such characteristics 530 may be associated with segmentations 540 including particular time periods, particular geographic areas, and particular transaction categories. Such segmentations 540 allow the purchase analysis computer system 112 to distinguish characteristics 530 in different conditions. For example, the transaction volume expected for grocery transactions between midnight and 4:00 AM may be substantially different from the transaction volume expected between 4:00 PM and 8:00 PM. Additionally, the distance traveled by cardholders for grocery transactions in a first urban geographic region may be less than the distance traveled by cardholders for grocery transactions in a second rural geographic region. (This assumes that grocery stores are more densely available in urban geographic regions than in rural geographic regions.) Further, stock-piling profiles 510 may include tolerance ranges 550 for each characteristic 530 and segmentation 540. Such tolerance ranges 550 reflect an amount by which transaction data (including historical transaction data 520 and current transaction data 560) may exceed expected cardholder transaction characteristics 530 before it is flagged as potentially tied to stock-piling behavior. For example, historical transaction data 520 may indicate an average value for each characteristic 530 but a distribution of the historical transaction data 520 for each characteristic 530 may indicate that much of historical transaction data 520 deviates from the average. Therefore, threshold 550 may be determined based in part on the distribution of historical transaction data 520 associated with each characteristic 530 of stock-piling profile 510.

A first illustrative stock-piling profile 510 is displayed below, segmented by transaction categories (Table 1):

TABLE 1

| | | | | Expected | Expected |
|---|---|---|---|---|---|
| | Expected | Expected | | Distance | Frequency |
| | Transactions | Transaction | | Traveled | of Purchase |
| Transaction | Volume per | Amount per | | per | per |
| Categories | Day | Day | | Transaction | Transaction |
| Grocery | 100,000,000 | $5 | billion | 10 miles | 1 transaction |
| | | | | | per 10 days |
| Hardware | 5,000,000 | $50 | million | 15 miles | 1 transaction |
| | | | | | per 60 days |
| Gasoline | 150,000,000 | $6 | billion | 5 miles | 1 transaction |
| | | | | | per 7 days |

Table 1 serves as a first illustration of a simple form of a stock-piling profile 510 because it is not fully segmented using segmentations 540. Stock-piling profile 510 of Table 1 is generally segmented by transaction category. Expected transaction and expected transaction amount are additionally segmented by day. Expected distance traveled and expected frequency of purchase are segmented by transaction. In many examples, further segmentation 540 will be useful to account for regional, temporal, or merchant variation. Such additional segmentation 540 can improve the effectiveness of stock-piling profiles 510 in detecting variances indicative of stock-piling behavior. Because external phenomena may be significantly associated with regions and time periods, a more detailed and segmented stock-piling profile may be beneficial. A second illustrative stock-piling profile is displayed below, segmented by transaction categories, and regions (Table 2). To simplify the display of the stock-piling profile 510 to the reader, fewer characteristics 530 are indicated. However, it is understood that additional characteristics 530 may be included:

TABLE 2

| | | Expected | Expected | | Expected |
|---|---|---|---|---|---|
| | | Transaction | Transaction | | Distance |
| Transaction | | Volume per | Amount per | | Traveled per |
| Categories | | Day | Day | | Transaction |
| Grocery | Region A | 30,000,000 | $.5 | billion | 5 miles |
| | Region B | 20,000,000 | $2 | billion | 15 miles |
| | Region C | 50,000,000 | $2.5 | billion | 10 miles |
| Hardware | Region A | 500,000 | $10 | million | 20 miles |
| | Region B | 2,500,000 | $20 | million | 5 miles |
| | Region C | 2,000,000 | $20 | million | 5 miles |
| Gasoline | Region A | 40,000,000 | $2.1 | billion | 3 miles |
| | Region B | 60,000,000 | $2.4 | billion | 10 miles |
| | Region C | 50,000,000 | $1.5 | billion | 10 miles |

Example stock-piling profiles 510 indicated in Tables 1 and 2 are provided for explication only. They are not restrictive and it should be understood that stock-piling profiles 510 generated and used by purchase analysis computer system 112 may be significantly different and more complex than stock-piling profiles 510 illustrated above. Further, stock-piling profiles 510 may further have thresholds or tolerance ranges 550 for characteristics 530 as described above and herein. Depending upon factors including the distribution of characteristics 530 in historical transaction data 520, greater or lesser thresholds or tolerance ranges 550 for variance from the stock-piling profile 510 may be allowed. In the example of Table 2, for example, Region A may include a broad distribution of distances traveled for grocery transactions. For example, 70% of all transactions may include travel of over 10 miles while 30% of all transactions include travel of less than 2 miles. As a result, an average expected range of travel for grocery transactions in Region A may be 5 miles but many examples of expected ranges of travel may exceed 5 miles. In this example, a tolerance range 550 of travel of 10 miles may be indicated.

Further, although many stock-piling profiles 510 are determined to include characteristics 530 based on averages from historical transaction data 520, other stock-piling profiles 510 may use additional mathematical models to determine such characteristics 530. Any suitable statistical or mathematical model may be used to determine such characteristics 530. Additionally, as described below, at least some stock-piling profiles 510 are generated by comparing periods known to be impacted by external phenomena to periods not impacted by external phenomena.

In the example embodiment, purchase analysis computer system 112 identifies patterns of cardholder transaction volumes for the plurality of categories of transactions. In the example embodiment, purchase analysis computer system 112 generates stock-piling profiles 510 with characteristics 530 for cardholder transaction volumes using segmentation 540 of transaction categories. More specifically, purchase analysis computer system 112 determines normal or expected ranges for cardholder transaction volumes for the plurality of categories of transactions. Based on the determined normal or expected ranges of cardholder transaction volume, purchase analysis computer system 112 generates stock-piling profiles 510. Stock-piling profile 510 may indicate a normal or expected transaction volume for each category of transaction as segmented by date, time, location, or other segmentation factors (or segmentations) 540. For example, some businesses may be seasonal or otherwise time-sensitive and have substantially different transaction volumes depending upon time of day or time of year. Therefore, stock-piling profiles 510 that take such temporal variance into account are more useful for identifying stock-piling behavior.

As described above, in other examples, purchase analysis computer system 112 generates stock-piling profiles 510 with other characteristics 530. Such stock-piling profiles 510 may identify transaction amounts (as expressed in currency values), distance traveled for purchases (by comparing merchant location to cardholder residence location), frequency of purchase in a time period, and frequency of purchase in a time period by a particular cardholder. Stock-piling profiles 510 with such additional information may also be segmented with segmentations 540 in a similar manner.

Including transaction amounts in characteristics 530 may be useful to identify stock-piling consumers that are making transactions of significant financial amounts. For example, consumers may make similar numbers of transactions while significantly increasing transaction amounts. In such examples, the consumers may be stock-piling even though transaction volume is unaffected. In such examples, purchase analysis computer system 112 receives the plurality of historical transaction data 520 and determines transaction amounts generally and for each segmentation 540. Based on the determined transaction amounts (and segmented transaction amounts), stock-piling profile 510 may be determined.

Including distance traveled for purchases in characteristics 530 may be useful to determine typical ranges of travel. As described below, if consumers are purchasing products from merchant locations at much greater distances from the cardholder residence location, purchase analysis computer system 112 may determine that such consumers are doing so to access more products that are becoming scarce due to stock-piling activity. In such examples, purchase analysis computer system 112 receives plurality of historical transaction data 520 and determines distances traveled for each segmentation 540. As noted above, in some examples, a cardholder residence location may first be derived based on other historic transaction data 520 associated with each cardholder. Similarly, a merchant location may be derived based on a merchant identifier or a merchant zip code. Based on the determined distances traveled (and segmented distances traveled), stock-piling profile 510 may be determined.

Including frequency of purchase generally may be useful to determine typical ranges of frequency of purchase. Similarly, frequency of purchase per cardholder may be useful to verify that individual cardholders are purchasing at greater frequency (as opposed to a sudden increase in popularity of a particular merchant or transaction category). Based on the determined frequencies of purchase (and segmented frequencies of purchase), stock-piling profile 510 may be determined.

In at least some examples, purchase analysis computer system 112 additionally generates stock-piling profiles 510 by factoring in external phenomena. In other words, at least some stock-piling profiles 510 determine the normal or expected transaction characteristics 530 at least partially by comparing such characteristics 530 in time periods that are influenced by external phenomena and time periods that are known to not be influenced by external phenomena. In such examples, purchase analysis computer system 112 may receive external phenomena information that allows purchase analysis computer system 112 to identify historical transaction data 520 associated with the external phenomena. Such external phenomena information may include dates and times associated with the external phenomena, geographical regions associated with the external phenomena, transaction categories associated with the external phenomena. Alternately, external phenomena may include any other suitable information. In one example, external phenomena information includes information related to an ice storm. Such external phenomena information may include the date of the announcement of the ice storm, the date of the impact of the ice storm, the geographical regions impacted by the ice storm, and transaction categories affected by the ice storm (e.g., fuel and groceries). Such external phenomena information may be substantially more detailed and identify the severity of the external phenomena as well as reported information on the impact of stock-piling due to the external phenomena. When such external phenomena information is available, purchase analysis computer system 112 identifies historical transaction data 520 that is associated with the external phenomena information as external phenomena transaction data. Purchase analysis computer system 112 processes such identified external phenomena transaction data in generating the stock-piling profiles. In one example, the external phenomena transaction data is excluded from the sample that is used to generate the expected ranges of characteristics 530 for stock-piling profiles 510 (because such external phenomena transaction data necessarily does not describe normal consumer transaction behavior). In a second example, the external phenomena transaction data is processed to determine models of expected deviations from characteristics caused by external phenomena. In all such examples, the external phenomena transaction data is used to adjust stock-piling profile 510.

In further examples, purchase analysis computer system 112 may analyze historical transaction data 520 to identify patterns of characteristics 530 in various segmentations 540. Where values of characteristics 530 significantly deviate from expected characteristics 530, purchase analysis computer system 112 may flag or otherwise identify such deviations as potentially associated with external phenomena. Purchase analysis computer system 112 may adjust stock-piling profiles 510 by ignoring such deviations or alternately adjusting the impact of such deviations. In other examples, a user may review the identified deviations for further analysis.

In at least some examples, concerns regarding access to banks or ATMs may cause consumers to withdraw larger amounts of money than are normal. Therefore, in at least some examples, stock-piling profiles 510 are generated specifically for the transaction category of bank transactions. In other words, stock-piling profiles 510 may include characteristics 530 associated with the withdrawal of money from a financial account or any other transactions associated with a financial account. Such stock-piling profiles 510 for bank transactions may include similar characteristics 530, segmentations 540, and thresholds or tolerance ranges 550 to those described above and herein. Specifically, transaction volumes, transaction amounts, distances traveled for transactions, and frequencies of transactions may be included in characteristics that are further segmented by date, time, and geographic region.

Purchase analysis computer system 112 retrieves at least one generated stock-piling profile 510, as described above, which may be used to identify transaction characteristics 530 consistent with a stock-piling event. As indicated above, each stock-piling profile 510 includes a plurality of ranges of expected cardholder characteristics 530 and a plurality of segmentations 540. In one example, stock-piling profile 510 includes a plurality of expected cardholder transaction volumes segmented by transaction category and further segmented by date and time. In another example, stock-piling profile 510 is further segmented by geographic region or area.

Purchase analysis computer system 112 also receives a plurality of transaction data 560. Plurality of transaction data 560 may also be referred to as plurality of current transaction data or plurality of present transaction data. The plurality of transaction data 560 includes a plurality of transaction data elements 562 that are substantially similar in type to plurality of historical transaction data elements 522. In the example embodiment, plurality of transaction data 560 is segmented by a plurality of categories of transactions. In the example embodiment, transaction data 560 represents present or recent data associated with present or recent transactions including, for example, transactions for the past 30 days.

Purchase analysis computer system 112 aggregates transaction data 560 from a plurality of transactions generally, and for each segmentation 540 indicated in stock-piling profiles 510. Accordingly, purchase analysis computer system 112 determines actual cardholder transaction characteristics 570 (e.g., actual cardholder transaction volume) for each actual segmentation 572 (e.g., for each transaction category.) In at least some examples, purchase analysis computer system 112 may determine actual cardholder transactions characteristics 570 for each actual segmentation 572. Actual segmentations 572 substantially mirror segmentations 540 and facilitate a similar segmenting of actual cardholder transaction characteristics 570 to allow for comparison to characteristics 530.

Purchase analysis computer system 112 identifies cardholder stock-piling behavior by comparing actual cardholder transaction characteristics 570 to the range of expected cardholder transaction characteristics 530, generally, and for each segmentation 540 and 572. In one example, purchase analysis computer system 112 identifies cardholder stock-piling behavior by comparing actual cardholder transaction volume to the range of expected cardholder transaction volume for each of a plurality of categories of transactions. More specifically, purchase analysis computer system 112 identifies whether actual cardholder transaction volume for each of the plurality of categories deviates from the expected values of the expected cardholder transaction volumes indicated in stock-piling profiles 510. In at least some examples, purchase analysis computer system 112 further factors in determined thresholds to identify potential stock-piling behavior. As described above, at least some characteristics 530 may include distributions where a range of “normal” characteristics may exist. In such examples, even though actual cardholder transaction characteristics 570 may vary from characteristics 530 of stock-piling profile 510, such variation may not exceed defined threshold or tolerance range 550 and stock-piling behavior may not be identified.

Because at least some segmentation 540 is geographic and temporal in nature, the stock-piling behavior may be identified for a particular region rather than generally. In other words, in some examples, actual cardholder transaction characteristics 570 will indicate stock-piling behavior in a particular region or for a particular transaction category but not in other regions or other transaction categories.

In some examples, actual cardholder transaction characteristics 570 may deviate from some stock-piling characteristics 530 but not from others. In other words, in some examples, some actual cardholder transaction characteristics 570 may indicate stock-piling behavior while others do not. Purchase analysis computer system 112 may be configured to only identify stock-piling behavior when actual cardholder transaction characteristics 570 deviate from a sufficient number of characteristics 530, as defined for each stock-piling profile 510. Such sufficient number of characteristics 530 may be defined by a user or by purchase analysis computer system 112. In other examples, particular characteristics 530 may be more determinative than others in identifying stock-piling behavior. In such examples, particular characteristics 530 and their importance may be defined by a user or by purchase analysis computer system 112.

In at least some examples, purchase analysis computer system 112 may further be configured to alert merchants 24 that may be impacted by identified stock-piling behavior by sending alert 580. For example, merchants 24 that are in a geographic region associated with the stock-piling behavior may be notified. Alternately, merchants 24 associated with a transaction category associated with the stock-piling behavior may be notified with alert 580. Such alerts 580 may be notifications of the stock-piling behavior generally. Alternately, purchase analysis computer system 112 may indicate a severity rating 582, wherein the severity rating indicates the severity of the stock-piling behavior. Alert 580 may also include suggested responses 584. In one example, alerted merchants may be advised to obtain more merchandise that is subject to being stock-piled. In another example, alerted merchants 24 may be advised to increase prices on stock-piled merchandise to reduce stock-piling behavior. In an additional example, merchants 24 may be advised to change operating hours to respond to the stock-piling behavior.

In at least some examples, purchase analysis computer system 112 may further alert other parties that may be affected by the stock-piling behavior including, for example, government agencies, news outlets, emergency services, and healthcare services.

As noted above, at least some stock-piling profiles 510 are generated for the specific case of bank transactions. In such examples, purchase analysis computer system 112 is configured to retrieve at least one stock-piling profile 510 wherein at least one stock-piling profile 510 includes a range of expected cardholder characteristics 530 associated with using a transaction card such as a debit card. Purchase analysis computer system 112 also receives a plurality of transaction data 560 associated with transaction card withdrawals from financial accounts associated with the transaction cards and determines actual transaction card characteristics. Purchase analysis computer system 112 also identifies cardholder stock-piling behavior by comparing the actual transaction card characteristics to the range of expected cardholder characteristics 530 associated with using transaction cards.

Further, at least some additional stock-piling profiles 510 are generated including characteristics 530 of the expected or normal distance of travel for transactions. In such examples, purchase analysis computer system 112 is configured to retrieve at least one stock-piling profile 510 including characteristics 530 of a geographic range associated with an expected distance that cardholders will travel for each segmentation and generally. Purchase analysis computer system 112 is also configured to determine an average distance traveled by cardholders for each segmentation 540 and generally based on the transaction data. Purchase analysis computer system 112 is also configured to identify cardholder stock-piling behavior by comparing the expected distance that cardholders will travel to the average distance traveled by cardholders generally and for each segmentation 540.

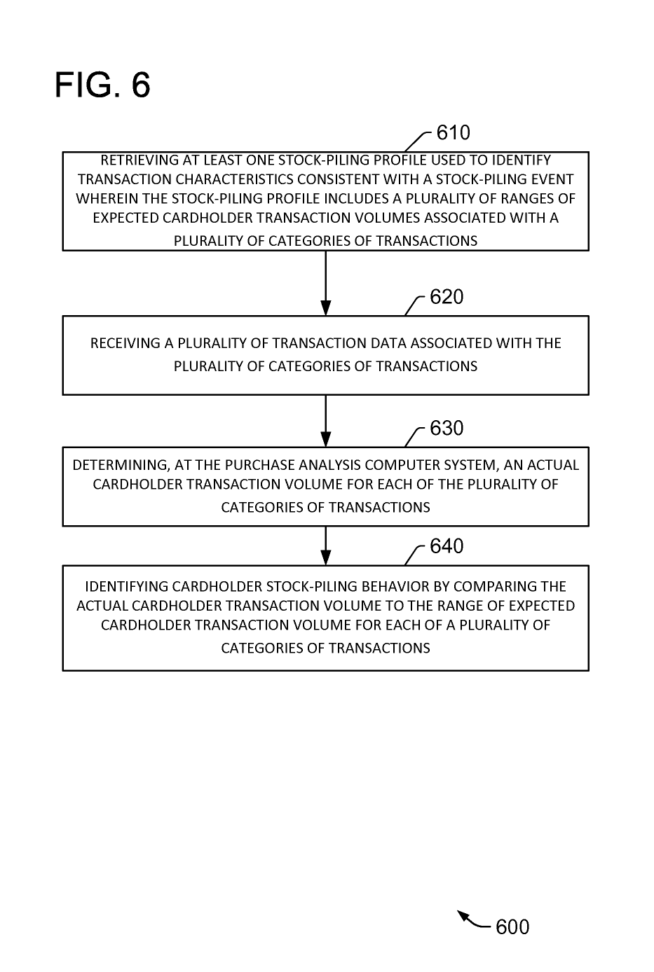

FIG. 6 is a simplified diagram of an example method 600 of identifying stock-piling behavior using purchase analysis computer system 112 (shown in FIGS. 2 and 3). Method 700 is accordingly carried out by purchase analysis computer system 112. Purchase analysis computer system 112 retrieves 610 at least one stock-piling profile used to identify transaction characteristics consistent with a stock-piling event wherein the stock-piling profile includes a plurality of ranges of expected cardholder transaction volumes associated with a plurality of categories of transactions. Retrieving 610 represents purchase analysis computer system 112 retrieving at least one stock-piling profile 510 (shown in FIG. 5) generated based on historical transaction data 520 (shown in FIG. 5) where stock-piling profile 510 includes characteristics 530, segmentations 540, and tolerance ranges 550 (also referred to as thresholds). Retrieving 610 further specifies that stock-piling profile 510 includes at least characteristic 530 for expected cardholder transaction volumes and at least segmentation 540 for transaction categories.

Purchase analysis computer system 112 also receives 620 a plurality of transaction data associated with the plurality of categories of transactions. Receiving 620 represents receiving transaction data 560 (shown in FIG. 5) including transaction data elements 562 (shown in FIG. 5). Further, transaction data 560 is associated with the segmentations 540 of stock-piling profile 510.

Purchase analysis computer system 112 additionally determines 630 an actual cardholder transaction volume for each of the plurality of categories of transactions. Determining 630 represents processing transaction data 560 to determine actual cardholder transaction characteristics 570 including actual cardholder transaction volumes.

Purchase analysis computer system 112 also identifies 640 cardholder stock-piling behavior by comparing the actual cardholder transaction volume to the range of expected cardholder transaction volume for each of a plurality of categories of transactions. Identifying 640 represents comparing characteristics 530 to actual cardholder transaction characteristics 570 for the same segmentations 540 and 572.

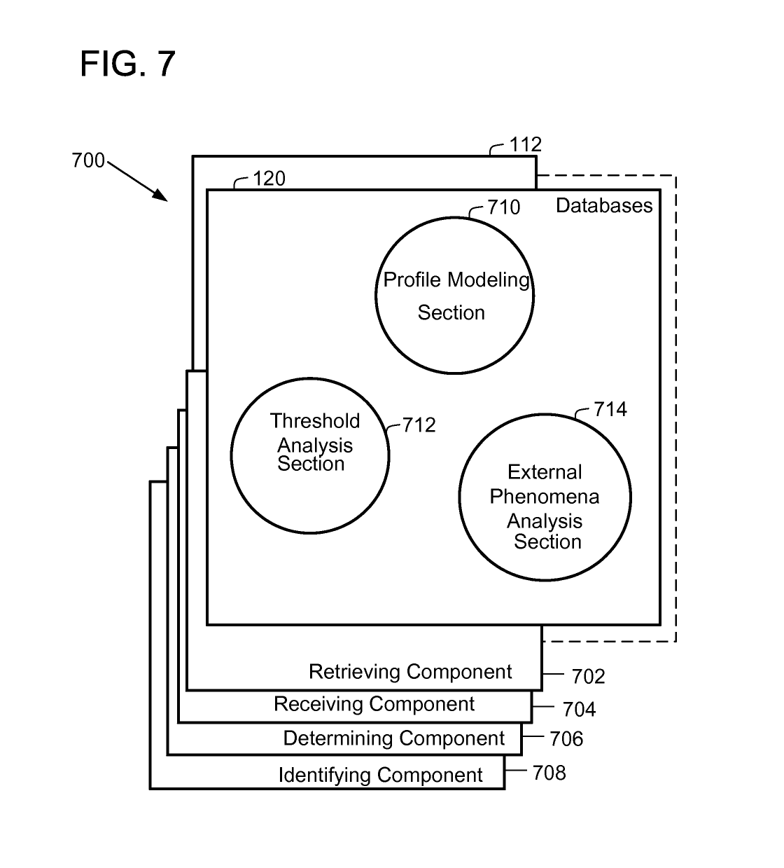

FIG. 7 is a diagram 700 of components of one or more example computing devices that may be used in the environment shown in FIG. 6. FIG. 7 further shows a configuration of databases including at least database 120 (shown in FIG. 1). Database 120 is coupled to several separate components within purchase analysis computer system 112, which perform specific tasks.

Purchase analysis computer system 112 includes a first retrieving component 702 for retrieving at least one stock-piling profile used to identify transaction characteristics consistent with a stock-piling event. Purchase analysis computer system 112 also includes a receiving component 704 for receiving a plurality of transaction data associated with the plurality of categories of transactions. Purchase analysis computer system 112 additionally includes a determining component 706 for determining an actual cardholder transaction volume for each of the plurality of categories of transactions. Purchase analysis computer system 112 also includes an identifying component 708 for identifying cardholder stock-piling behavior by comparing the actual cardholder transaction volume to the range of expected cardholder transaction volume for each of a plurality of categories of transactions.

In an exemplary embodiment, database 120 is divided into a plurality of sections, including but not limited to, a profile modelling section 710, a threshold analysis section 712, and an external phenomena analysis section 714. These sections within database 120 are interconnected to update and retrieve the information as required.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for identifying cardholder stock-piling behavior, the method implemented by a purchase analysis computer system in communication with a memory, the method comprising:
retrieving at least one stock-piling profile used to identify transaction characteristics consistent with a stock-piling event wherein the stock-piling profile includes a plurality of ranges of expected cardholder transaction volumes associated with a plurality of categories of transactions;
receiving a plurality of transaction data associated with the plurality of categories of transactions;
determining, at the purchase analysis computer system, an actual cardholder transaction volume for each of the plurality of categories of transactions; and
identifying cardholder stock-piling behavior by comparing the actual cardholder transaction volume to the range of expected cardholder transaction volume for each of a plurality of categories of transactions.

2. The method of claim 1, further comprising:
receiving a plurality of historical transaction data associated with each of the plurality of categories of transactions;
determining the plurality of ranges of expected cardholder transaction volumes associated with the plurality of categories of transactions based on the historical transaction data; and
generating the at least one stock-piling profile based on the determined plurality of ranges of expected cardholder transaction volumes.

3. The method of claim 2, further comprising:
receiving a time range associated with at least one external phenomena;
identifying variations between cardholder transaction volumes during the time range and cardholder transaction volumes not during the time range; and
adjusting the at least one stock-piling profile based on the identified variations.

4. The method of claim 1, further comprising:
determining a plurality of geographic regions; and
identifying cardholder stock-piling behavior for each of the determined plurality of geographic regions.

5. The method of claim 1, further comprising:
alerting a plurality of merchants associated with identified cardholder stock-piling behavior.

6. The method of claim 5, further comprising:
recommending an inventory response to the plurality of merchants based on the identified cardholder stock-piling behavior.

7. The method of claim 1, further comprising:
retrieving the at least one stock-piling profile wherein the at least one stock-piling profile includes a range of expected cardholder withdrawals from a plurality of cardholder financial accounts using a plurality of transaction cards;
receiving the plurality of transaction data associated with actual withdrawals using the plurality of transaction cards from the plurality of cardholder financial accounts;
determining an actual transaction card withdrawal total based on the actual withdrawals from the plurality of cardholder financial accounts using the plurality of transaction cards; and
identifying cardholder stock-piling behavior by comparing the actual transaction card withdrawal total to the range of expected cardholder withdrawals from the plurality of cardholder financial accounts using the plurality of transaction cards.

8. The method of claim 1, further comprising:
retrieving the at least one stock-piling profile wherein the at least one stock-piling profile includes a geographic range associated with an expected distance that cardholders will travel to purchase particular goods;
determining, based on the transaction data, an average distance traveled by cardholders for each of the plurality of categories of transactions; and
identifying cardholder stock-piling behavior by comparing the expected distance that cardholders will travel to purchase particular goods to the average distance traveled by cardholders for each of the plurality of categories of transactions.

9. A purchase analysis computer system used to identify cardholder stock-piling behavior, the purchase analysis computer system comprising:
a processor; and
a memory coupled to said processor, said processor configured to:
retrieve at least one stock-piling profile used to identify transaction characteristics consistent with a stock-piling event wherein the stock-piling profile includes a plurality of ranges of expected cardholder transaction volumes associated with a plurality of categories of transactions;
receive a plurality of transaction data associated with the plurality of categories of transactions;
determine an actual cardholder transaction volume for each of the plurality of categories of transactions; and
identify cardholder stock-piling behavior by comparing the actual cardholder transaction volume to the range of expected cardholder transaction volume for each of a plurality of categories of transactions.

10. A purchase analysis computer system in accordance with claim 9 wherein the processor is further configured to:
receive a plurality of historical transaction data associated with each of the plurality of categories of transactions;
determine the plurality of ranges of expected cardholder transaction volumes associated with the plurality of categories of transactions based on the historical transaction data; and
generate the at least one stock-piling profile based on the determined plurality of ranges of expected cardholder transaction volumes.

11. A purchase analysis computer system in accordance with claim 10 wherein the processor is further configured to:
receive a time range associated with at least one external phenomena;
identify variations between cardholder transaction volumes during the time range and cardholder transaction volumes not during the time range; and
adjust the at least one stock-piling profile based on the identified variations.

12. A purchase analysis computer system in accordance with claim 9 wherein the processor is further configured to:
determine a plurality of geographic regions; and
identify cardholder stock-piling behavior for each of the determined plurality of geographic regions.

13. A purchase analysis computer system in accordance with claim 9 wherein the processor is further configured to:
alert a plurality of merchants associated with identified cardholder stock-piling behavior.

14. A purchase analysis computer system in accordance with claim 13 wherein the processor is further configured to:
recommend an inventory response to the plurality of merchants based on the identified cardholder stock-piling behavior.

15. A purchase analysis computer system in accordance with claim 9 wherein the processor is further configured to:
retrieving the at least one stock-piling profile wherein the at least one stock-piling profile includes a range of expected cardholder withdrawals from a plurality of cardholder financial accounts using a plurality of transaction cards;
receiving the plurality of transaction data associated with actual withdrawals using the plurality of transaction cards from the plurality of cardholder financial accounts;
determining an actual transaction card withdrawal total based on the actual withdrawals from the plurality of cardholder financial accounts using the plurality of transaction cards; and
identifying cardholder stock-piling behavior by comparing the actual transaction card withdrawal total to the range of expected cardholder withdrawals from the plurality of cardholder financial accounts using the plurality of transaction cards.

16. A purchase analysis computer system in accordance with claim 9 wherein the processor is further configured to:
retrieve the at least one stock-piling profile wherein the at least one stock-piling profile includes a geographic range associated with an expected distance that cardholders will travel to purchase particular goods;
determine, based on the transaction data, an average distance traveled by cardholders for each of the plurality of categories of transactions; and
identify cardholder stock-piling behavior by comparing the expected distance that cardholders will travel to purchase particular goods to the average distance traveled by cardholders for each of the plurality of categories of transactions.

17. Computer-readable storage media for identifying cardholder stock-piling behavior, the computer-readable storage media having computer-executable instructions embodied thereon, wherein, when executed by at least one processor, the computer-executable instructions cause the processor to:
retrieve at least one stock-piling profile used to identify transaction characteristics consistent with a stock-piling event wherein the stock-piling profile includes a plurality of ranges of expected cardholder transaction volumes associated with a plurality of categories of transactions;
receive a plurality of transaction data associated with the plurality of categories of transactions;
determine an actual cardholder transaction volume for each of the plurality of categories of transactions; and
identify cardholder stock-piling behavior by comparing the actual cardholder transaction volume to the range of expected cardholder transaction volume for each of a plurality of categories of transactions.

18. The computer-readable storage media in accordance with claim 17, wherein the computer-executable instructions cause the processor to:
receive a plurality of historical transaction data associated with each of the plurality of categories of transactions;
determine the plurality of ranges of expected cardholder transaction volumes associated with the plurality of categories of transactions based on the historical transaction data; and
generate the at least one stock-piling profile based on the determined plurality of ranges of expected cardholder transaction volumes.

19. The computer-readable storage media in accordance with claim 18, wherein the computer-executable instructions cause the processor to:
receive a time range associated with at least one external phenomena;
identify variations between cardholder transaction volumes during the time range and cardholder transaction volumes not during the time range; and
adjust the at least one stock-piling profile based on the identified variations.

20. The computer-readable storage media in accordance with claim 17, wherein the computer-executable instructions cause the processor to:
determine a plurality of geographic regions; and
identify cardholder stock-piling behavior for each of the determined plurality of geographic regions.
